(19) United States
(12) Patent Application Publication
(10) Pub. No.: US 2025/0377510 A1
(43) Pub. Date: Dec. 11, 2025

(54) APPARATUS FOR ALIGNING OPTICAL COUPLING STRUCTURE WITH PHOTONIC INTEGRATED CIRCUIT

(71) Applicant: AIP Inc., New Taipei City (TW)

(72) Inventor: Chia LEE, New Taipei City (TW)

(73) Assignee: AIP Inc., New Taipei City (TW)

(21) Appl. No.: 19/089,040

(22) Filed: Mar. 25, 2025

Related U.S. Application Data
(60) Provisional application No. 63/657,872, filed on Jun. 9, 2024.

(51) Int. Cl. G02B 6/42

(52) U.S. Cl. CPC G02B 6/4221

(57) ABSTRACT

An apparatus for aligning an optical coupling structure with a photonic integrated circuit is provided. The apparatus includes at least an imaging device and a multiaxial adjustment device. The imaging device is configured to generate a three-dimensional image reflecting positional relation between the optical coupling structure and the photonic integrated circuit. The multiaxial adjustment device is electrically connected to the imaging device and includes at least an adjustment platform and at least a holding arm connected to the adjustment platform, the holding arm holding the optical coupling structure and being movable under control of the adjustment platform according to the three-dimensional image for the alignment between the optical coupling structure and the photonic integrated circuit.

### CROSS REFERENCE TO RELATED APPLICATIONS

This application claims the benefit of U.S. provisional patent application Ser. No. 63/657,872, filed Jun. 9, 2024, the entirety of which is incorporated by reference herein.

### BACKGROUND OF INVENTION

### 1. Field of Invention

The present invention relates to a technical field of optical alignment, and particularly to an apparatus for aligning an optical coupling structure with a photonic integrated circuit.

### 2. Related Art

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment. OEICs are configured with photonic integrated circuits (PICs) and electronic integrated circuits (EICs) and are generally co-packaged as co-packaged optics (CPO).

PICs, are commonly used, for example, in optical routers and switches, generally include input and/or output couplers for optically connecting the PICs to optical fibers or other external optical connectors. To ensure efficient coupling of light between optical connectors and the PICs, communication channels of optical connectors (e.g., individual fibers) need to be precisely aligned with the input/output couplers of the PICs. During active alignment, light may be coupled from the optical connectors into input couplers of the PICs and measured by detectors of the PICs, or, alternatively, light generated by on-chip light sources may be coupled from output couplers of the PICs into the optical connectors and measured by external detectors. However, conventional active alignment is time-consuming, which is not conducive to improvement in productivity and yield.

### SUMMARY OF INVENTION

An object of the present application is to provide an apparatus, which uses at least an imaging device and a multiaxial adjustment device operating together to enable a precise optical alignment between an optical coupling structure and a photonic integrated circuit, thus achieving efficient and less time-consuming optical coupling.

To achieve the above-mentioned object, the present application provides an apparatus for aligning an optical coupling structure with a photonic integrated circuit, the apparatus including at least an imaging device and a multiaxial adjustment device. The imaging device is configured to generate a three-dimensional image reflecting positional relation between the optical coupling structure and the photonic integrated circuit. The multiaxial adjustment device is electrically connected to the imaging device and includes at least an adjustment platform and at least a holding arm connected to the adjustment platform, the holding arm holding the optical coupling structure and being movable under control of the adjustment platform according to the three-dimensional image for the alignment between the optical coupling structure and the photonic integrated circuit.

Optionally, a plurality of the imaging devices are provided, each of the imaging devices includes a fixing arm and a scanning module disposed on the fixing arm, and the scanning module includes a scanning head located facing the optical coupling structure and the photonic integrated circuit.

Optionally, a plurality of the adjustment platforms and the holding arms are provided, and each of the holding arms is independently adjustable in position under control of a respective one of the adjustment platforms.

Optionally, the holding arms are arranged in alignment with each other, and the scanning modules are located at opposite sides of the two outermost holding arms.

Optionally, the holding arms are simultaneously adjustable in position to hold and actively align a plurality of the optical coupling structures with a plurality of the photonic integrated circuits, respectively.

Optionally, at least four adjustment platforms and at least four holding arms are provided, the adjustment platforms are arranged above the scanning modules, and the holding arms hold the optical coupling structures in such a way that the optical coupling structures are arranged to be flush with each other.

Optionally, each of the scanning modules is adjustable in position relative to the holding arms.

Optionally, the multiaxial adjustment device further includes a suspending member disposed above the photonic integrated circuit, one end of the fixing arm is connected to a side of the suspending member, the scanning head is exposed at an end of the scanning module away from the fixing arm, and the adjustment platform is disposed on another side of the suspending member.

Optionally, the holding arm includes a holding head disposed on one end of the holding arm, and the holding head is configured to hold the optical coupling structure.

Optionally, the apparatus further includes a dispensing device, wherein the dispensing device is configured to apply a curing substance on the photonic integrated circuits and fix a position of the optical coupling structure.

Optionally, the dispensing device includes at least a dispensing tube and at least a curing element, the dispensing tube dispenses the curing substance, and the curing element cures the curing substance.

Optionally, a plurality of the curing elements are arranged on opposite sides of the holding arm, and the dispensing tube is movable to the optical coupling structure according to the three-dimensional image.

Optionally, a co-packaged optics assembly is provided and comprises a main board, an electronic integrated circuit, a load board, and the photonic integrated circuit, and the photonic integrated circuit, the electronic integrated circuit, and the load board are electrically arranged on the main board.

In the present application, the multiaxial adjustment device of the apparatus, in response to receiving the image signals output from the imaging device spatially and electronically scanning the site where the optical coupling structures are to be positioned, adjusts the positions of the optical coupling structures to enable a precise optical alignment between the optical coupling structures and the photonic integrated circuits, respectively and simultaneously thus achieving efficient and less time-consuming optical alignment.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic perspective view of an apparatus for aligning an optical coupling structure with a photonic integrated circuit in an embodiment of the present application.

FIG. 2 is a partially enlarged perspective view of the apparatus of FIG. 1.

FIG. 2A is a schematic top plane view showing an arrangement of imaging devices provided in an embodiment of the present application.

FIG. 3 is a schematic perspective view showing a plurality of adjustment platforms and holding arms in an embodiment of the present application.

FIG. 4 is a schematic partial bottom plan view of the adjustment platforms and the holding arms shown in FIG. 3.

FIG. 5 is a partially enlarged perspective view showing the apparatus holding an optical coupling structure to be in optical alignment with a photonic integrated circuit.

FIG. 5A is a schematic front view of an apparatus for aligning an optical coupling structure with a photonic integrated circuit in another embodiment of the present application.

FIGS. 6A to 6F are schematic views of various situations of the optical alignment between an optical coupling structure and a photonic integrated circuit before the adjustment of the apparatus.

FIG. 7 is a partially enlarged view showing the apparatus holding a plurality of optical coupling structures to be in optical alignment with a photonic integrated circuit on a co-packaged optics assembly.

FIG. 8 is a schematic perspective view of the apparatus of the present application provided to align the optical coupling structures with the photonic integrated circuit of FIG. 7.

FIG. 9 is a partially enlarged view of FIG. 8 wherein the plurality of optical coupling structures are in optical alignment with photonic integrated circuits.

### DESCRIPTION OF PREFERRED EMBODIMENTS

The following embodiments refer to the accompanying drawings for exemplifying specific implementable embodiments of the present invention. Directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component, or a first section discussed below could be termed a second element, a second component or a second section without departing from the teachings of the present application.

Unless the context indicates otherwise, terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes.

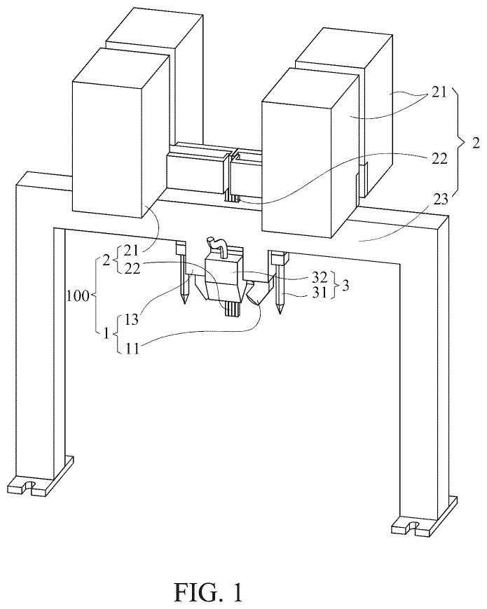

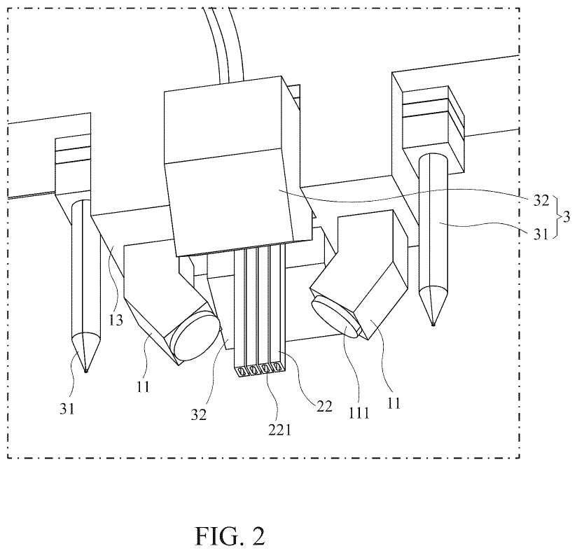

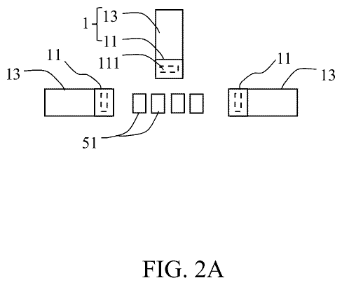

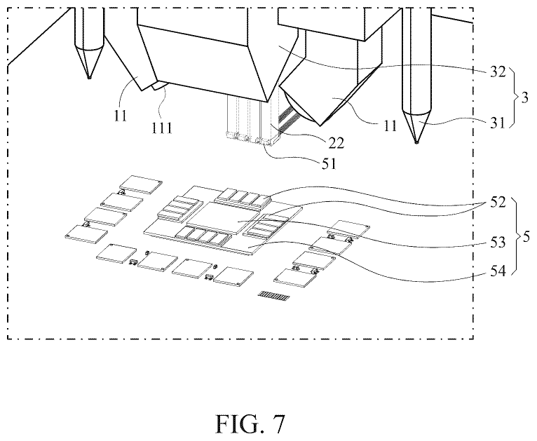

The present application provides an apparatus for aligning at least an optical coupling structure with a photonically-enabled integrated circuit. More specifically, one or a plurality of the optical coupling structures connected with optical fibers are optically coupled with one or a plurality of photonic integrated circuits for light signal transmission between the photonically-enabled integrated circuit and an applied device. In detail, the photonically-enabled integrated circuit is an optoelectronic integrated circuit including photonic integrated circuits (PICs) and electronic integrated circuits (EICs) and is configured for electro-optic conversion and optic-electro conversion. The photonically-enabled integrated circuit, for example, may be applied to switches or systems operating with co-packaged optics (CPO)-based devices. Referring to FIGS. 1 and 2, FIG. 1 is a schematic perspective view of an apparatus 100 in accordance with an embodiment of the present application, and FIG. 2 is a partially enlarged perspective view of the apparatus 100 of FIG. 1. As shown in FIG. 1, the apparatus 100 is provided to actively align an optical coupling structure 51 with a photonic integrated circuit 52 (as shown in FIG. 7, described further below) and includes at least an imaging device 1 and a multiaxial adjustment device 2. Preferably, the apparatus 100 includes a plurality of the imaging devices 1.

As shown in FIG. 1, two imaging devices 1 are spaced apart from each other and arranged above the photonic integrated circuit 52 (see FIG. 7). Each of the imaging devices 1 includes a scanning module 11 and a fixing arm 13. Specifically, as shown in FIG. 2, the scanning module 11 is disposed on the fixing arm 13 and includes a scanning head 111. The scanning head 111 is exposed at an end of the scanning module 11 away from the fixing arm 13 and faces the optical coupling structure 51 and the photonic integrated circuit 52. Preferably, the scanning heads 111 are oriented in different directions towards a same site where the optical coupling structure 51 and the photonic integrated circuit 52 are positioned (see FIG. 7). In some embodiments, the scanning heads 111 are arranged on left and right sides of the optical coupling structure 51. As shown in FIG. 2, the scanning module 11 may be structured with a tube-shaped casing bent toward the site and allows for ease of scanning.

Referring to FIG. 2A, which is a schematic top plane view showing an arrangement of the imaging devices 1 in an embodiment of the present application, three imaging devices 1 are provided for a broad scanning area around the optical coupling structure 51. In this embodiment, one of the imaging devices 1 is arranged on a rear side of the optical coupling structure 51 between the other two imaging devices 1. It should be noted that the number of the imaging device 1 is determined according to actual requirements.

Specifically, each of the imaging devices 1 is configured to generate a three-dimensional image reflecting positional relation between the optical coupling structure 51 and the photonic integrated circuit 52. In some embodiments, the imaging device 1 may be an optical coherence tomography (OCT) device, which uses interferometry with short-coherence-length light to obtain micrometer to nanometer-level depth resolution and uses transverse scanning of the light beam to form two-dimensional and three-dimensional images from light reflected from within target such as semiconductor structure, biological tissue or other scattering media. In some other embodiments, the imaging device 1 may be a three-dimensional (3D) scanner or a 3D laser scanner, which may be portable in use, with the fixing arm 13 held by users. Since the specific structures and working principle of OCT devices and 3D scanners are well known in the art, their details will not be described herein.

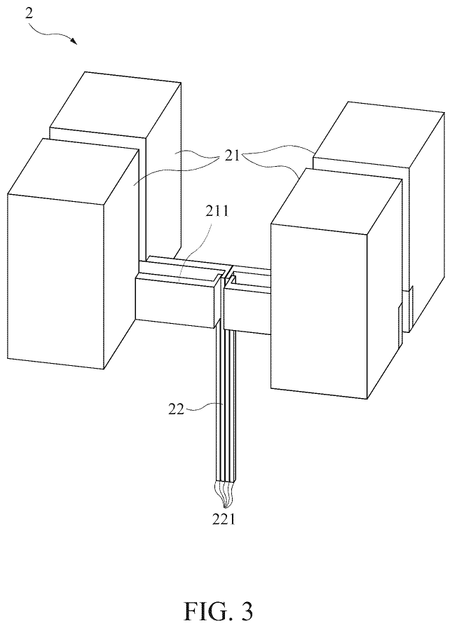

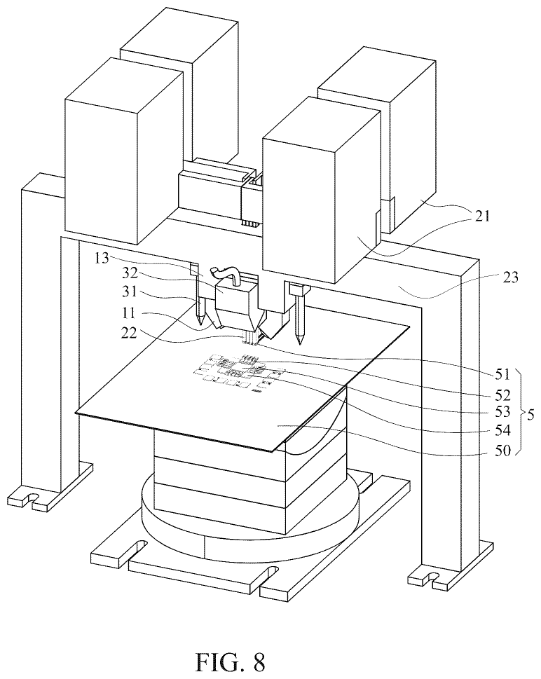

Referring to FIG. 3 and FIG. 1, FIG. 3 schematically shows the arrangement of a plurality of adjustment platforms 21 and holding arms 22. The multiaxial adjustment device 2 is electrically connected to the imaging devices 1 (not shown) and provides at least three degrees of freedom of movement in 3D space. Preferably, the multiaxial adjustment device 2 is a six-axial adjustment device, which provides six degrees of freedom of movement, and includes four adjustment platforms 21 and four holding arms 22 connected to the adjustment platforms 21, respectively. In this embodiment, as shown in FIG. 1, the multiaxial adjustment device 2 further includes a suspending member 23, which is disposed above the photonic integrated circuit 52 (as shown in FIG. 8, described further below) and configured to support the adjustment platforms 21 and the imaging devices 1. In detail, the four adjustment platforms 21 are separately arranged as two sets located above the scanning modules 11. Two of the adjustment platforms 21 are arranged side-by-side and the other two of the adjustment platforms 21 are arranged side-by-side on a same side of the suspending member 23. As shown in FIG. 1, one end of the fixing arm 13 is connected to a side of the suspending member 23 opposite to the adjustment platforms 21, and the scanning modules 11 are located below and between the four adjustment platforms 21.

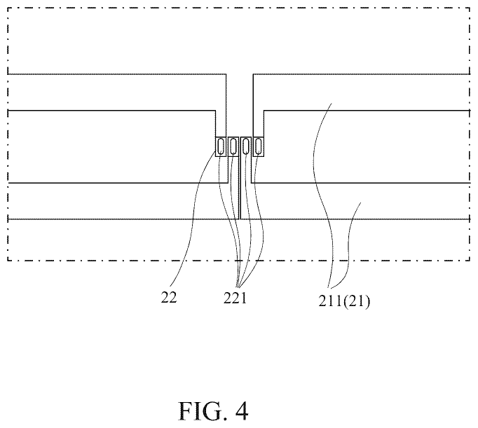

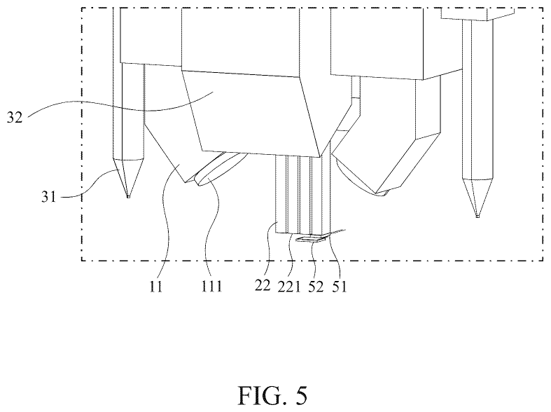

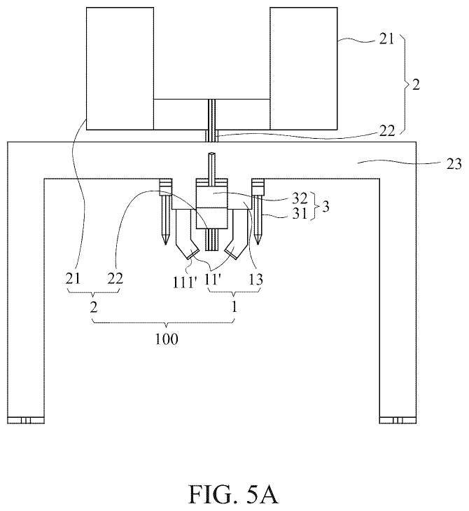

Referring to FIGS. 4 and 5, FIG. 4 is a schematic partial bottom plan view of the adjustment platforms 21 and the holding arms 22 shown in FIG. 3, and FIG. 5 is a partially enlarged perspective view showing the apparatus 1 holding the optical coupling structure 51 to be in optical alignment with the photonic integrated circuit 52. As shown in FIGS. 3 and 4, each of the adjustment platforms 21 includes an extending arm 211 extending laterally from a corner portion of respective adjustment platform 21 toward a substantially middle position between the four adjustment platforms 21 such that the extending arms 211 are arranged above the suspending member 23 and surrounded by the adjustment platforms 21 (as shown in FIG. 1). A bottom of the extending arm 211 is connected with the holding arm 22. In this embodiment, the holding arms 22 are arranged in alignment with each other between the four adjustment platforms 21 and extend downward through the suspending member 23 (see FIG. 1).

Specifically, as shown in FIGS. 3 to 5, each of the holding arms 22 has a holding head 221, which is configured to hold the optical coupling structure 51. As shown in FIG. 5, the holding head 221 is disposed on one end of the holding arm 22 and arranged according to the configuration of the photonic integrated circuit 52 (as shown in FIG. 7). In this embodiment, as shown in FIG. 4, the holding heads 221 are arranged in a row and are flush with each other. As shown in FIG. 5, the holding arms 22 hold the optical coupling structure 51 and is movable under control of the adjustment platforms 21 according to the three-dimensional image for the alignment between the optical coupling structure 51 and the photonic integrated circuit 52. Each of the holding arms 22 is independently adjustable in position under control of a respective one of the adjustment platforms 21. In this embodiment, the holding head 221 of the holding arm 22 is configured to hold the optical coupling structure 51 by means of suctioning, but is not limited to thereto. Specifically, the holding arms 22 hold the optical coupling structures 51 in such a way that the optical coupling structures 51 are arranged to be flush with each other to facilitate efficient optical coupling between the optical coupling structures 51 and the photonic integrated circuits 52.

Referring to FIG. 5A, which is a schematic front view of an apparatus 100 in an embodiment of the present application, in this embodiment, each of the scanning modules 11′ may be adjustable in position relative to the holding arms 22. The scanning modules 11′ are movable to be lower than the holding arms 22 so that the scanning heads 111′ can be closer to the photonic integrated circuits 52 that is conducive to achieving a more precise alignment between the optical coupling structures 51 and the photonic integrated circuits 52.

In other embodiments, the multiaxial adjustment device 2 may be held and moveable by a mechanical arm (not shown). It is noted that the working principle of the six degrees of freedom of movement of the multiaxial adjustment device 2 is known in the art and is therefore not described in detail herein. The number of the adjustment platforms 21 and the holding arms 22, may be two or six, which is determined according to actual requirements. Each of the adjustment platforms 21 with its holding arm 22 is operating independently from each other for improving efficiency of optical alignment. In some embodiments, a plurality of the optical coupling structures 51 (see FIG. 7 below) can be positioned at the same time to optically couple with the photonic integrated circuits 52 through the concurrent adjustment of the holding arms 22 based on the three-dimensional image. Alternatively, the holding arms 22 may be adjusted in position separately until all the optical coupling structures 51 are optically coupled with the photonic integrated circuits 52.

Referring to FIG. 5 and FIG. 1, the scanning modules 11 are symmetrically arranged toward the same site where the optical coupling structure 51 is positioned. In this embodiment, the scanning modules 11 are located at opposite sides of the two outermost holding arms 22. The holding arms 22 are simultaneously adjustable in position to hold and actively align a plurality of the optical coupling structures 51 with a plurality of the photonic integrated circuits 52, respectively. As shown in FIG. 5, the holding head 221 sucks a part of the optical coupling structure 51 and moves to be in optical alignment with the photonic integrated circuit 52 (also referred to as optical engine).

As shown in FIGS. 1 and 2, the apparatus 100 further includes a dispensing device 3. The dispensing device 3 is configured to apply a curing substance on the optical coupling structure 51 or the photonic integrated circuit 52 to fix the position of the optical coupling structure 51 with the photonic integrated circuit 52. In detail, the dispensing device 3 includes at least a dispensing tube 31 and at least a curing element 32 that are arranged above the optical coupling structure 51 (see FIG. 7 below). The dispensing tube 31 dispenses the curing substance, and the curing element 32 cures the curing substance. As shown in FIG. 2, in this embodiment, two curing elements 32 are disposed between the two scanning modules 11 and are arranged on opposite sides of the holding arms 22. Specifically, the holding arms 22 are located between the curing elements 32 such that the curing elements 32 are disposed in a front-to-back arrangement with respect to the holding arms 22. Two dispensing tubes 31 are provided and movable to the optical coupling structures 51 according to the three-dimensional image.

In some embodiments, the curing elements 32 serve as an ultra-violet (UV) light source and use an ultra-violet (UV) ray to cure the curing substance. Specifically, the dispensing tube 31 is configured to dispense UV glue. The curing elements 32 cure the UV glue (i.e., the curing substance) by UV ray after the optical coupling structure 51 is in precisely optical alignment with the photonic integrated circuit 52, so as to fix the optical coupling structure 51 in place.

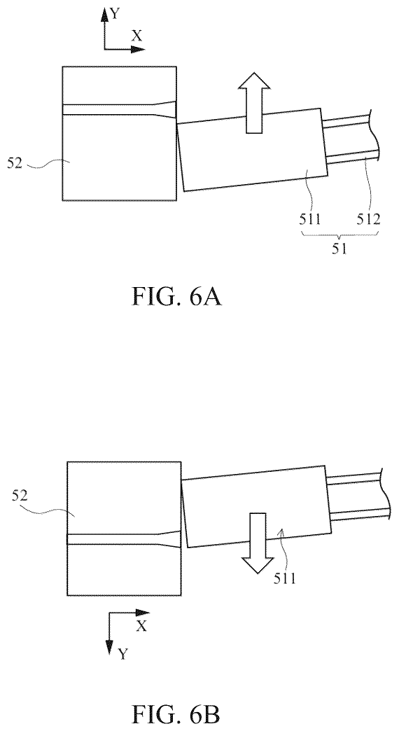

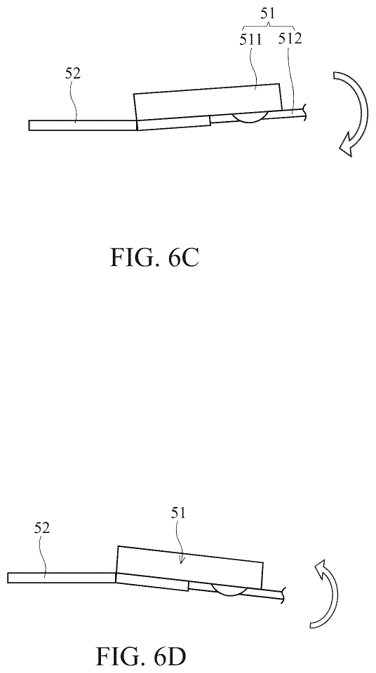

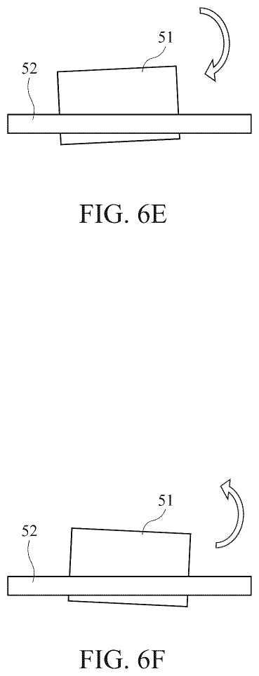

Referring to FIGS. 6A to 6F, FIGS. 6A to 6F are schematic views of various situations of the optical alignment between the optical coupling structure 51 and the photonic integrated circuit 52 before the adjustment of the apparatus 100. As shown in FIGS. 6A to 6F, in some embodiments, the optical coupling structure 51 includes a connecting assembly 511 and a plurality of optical fibers 512 connected to the connecting assembly 511. In a process of optical alignment, the optical coupling structure 51 may need to be adjusted in position to precisely aligned with the photonic integrated circuit 52. For example, as shown in FIGS. 6A and 6B, the optical coupling structure 51 is adjusted to move transversely from a top plan view so as to be aligned with the photonic integrated circuit 52. As shown in FIGS. 6C and 6D, the optical coupling structure 51 is adjusted in position to be aligned with the photonic integrated circuit 52 from a side plan view in which the optical coupling structure 51 tilts upward at a read end with respect to the photonic integrated circuit 52 as shown in FIG. 6C and tilts downward at the rear end with respect to the photonic integrated circuit 52 as shown in FIG. 6D. FIGS. 6E and 6F schematically show the optical coupling structure 51 is adjusted in position over the photonic integrated circuit 52 from a front plan view, inasmuch as the optical coupling structure 51 tilts lift downward with respect to the photonic integrated circuit 52 as shown in FIG. 6E, and the optical coupling structure 51 tilts right downward with respect to the photonic integrated circuit 52 as shown in FIG. 6F.

As noted above, the three-dimensional image contains the positional relation between the optical coupling structures 51 and the photonic integrated circuits 52 in X-axis, Y-axis, and Z-axis directions, and the positional relation between the holding heads 221 of the holding arms 22 and the optical coupling structures 51 as well as between the holding heads 221 and the photonic integrated circuits 52. In addition, the three-dimensional image also contains the positional relation among the dispensing device 3, the optical coupling structures 51, and the photonic integrated circuits 52 for precise dispensing of the curing substance.

The multiaxial adjustment device 2, according to the three-dimensional image generated by the imaging device 1, manages to adjust the position of the optical coupling structure 51 held by the holding arm 22 to align with the photonic integrated circuit 52. In this fashion, the imaging device 1 and the multiaxial adjustment device 2 work in tandem for the precise alignment between the optical coupling structure 51 and the photonic integrated circuit 52, thereby achieving efficient and less time-consuming optical coupling.

In detail, the scanning module 11 includes an image processing circuit (not shown) and an output circuit (not shown). The image processing circuit is configured to process image data obtained by the scanning of the scanning head 111 and generate a three-dimensional image based on the image data. The output circuit is configured to output image signals based on the image data to a transceiver circuit (not shown) included in the adjustment platform 21. The adjustment platform 21 includes a control circuit (not shown) configured to control the holding arm 22 to finely move until the optical coupling structure 51 is precisely optically coupled with the photonic integrated circuit 52. As used herein, the term “module” may refer to, be part of, or include an ASIC, an electronic circuit, a processor (shared, dedicated, or group), and/or memory (shared, dedicated, or group) that execute one or more software or firmware programs, a combinational logic circuit, and/or other suitable components that provide the described functionality.

Referring to FIGS. 7 and 8, FIG. 7 is a partially enlarged view showing the apparatus 100 holding a plurality of the optical coupling structures 51 to be in optical alignment with a plurality of the photonic integrated circuit 52, and FIG. 8 is a schematic perspective view showing the apparatus 100 and a co-packaged optics assembly 5 provided in an embodiment of the present application. In some embodiments, the co-packaged optics assembly 5 includes a main board 50, the photonic integrated circuit 52, an electronic integrated circuit 53 (e.g., application specific integrated circuit, ASIC), and a load board 54. The electronic integrated circuit 53 and the load board 54 are electrically arranged on the main board 50. In this embodiment, the photonic integrated circuit 52, the electronic integrated circuit 53, and the load board 54 jointly define the photonically-enabled integrated circuit. In other embodiments, the photonically-enabled integrated circuit may further include the main board 50.

As shown in FIG. 7, in optical coupling, first, the scanning module 11 of the imaging device 1 spatially and electronically scans the site where the optical coupling structures 51 and the photonic integrated circuits 52 are positioned, then the three-dimensional image is generated and sent to the adjustment platforms 21. Based on the three-dimensional image, the plurality of holding arms 22 each hold the optical coupling structures 51 to move to the position where the optical coupling structures 51 are in optical alignment with the photonic integrated circuits 52, respectively, on a side of the load board 54 close to the electronic integrated circuit 53, thereby completing the optical alignment between the optical coupling structures 51 and the photonic integrated circuits 52 at one time. In this fashion, the process of optical coupling can be efficient and precise since the exact position of the photonic integrated circuits 52 are obtained in advance even without the active alignment process as used in the art can be omitted.

Certainly, after optically aligning the optical coupling structures 51 with the photonic integrated circuits 52 through the use of the imaging device 1, the active alignment process can further be performed by aiding of the multiaxial adjustment devices 2 to make sure light signals are completely transmitted between the photonic integrated circuit 52 and the optical coupling structure 51, thus achieving a more precise optical alignment. In some embodiments, two apparatus 100 may be arranged in opposite directions to manage to optically align eight optical coupling structures 51 at one time on opposite sides of the load board 54, respectively. It should be noted that the number of the apparatus 100 to be provided varies depending on actual requirements.

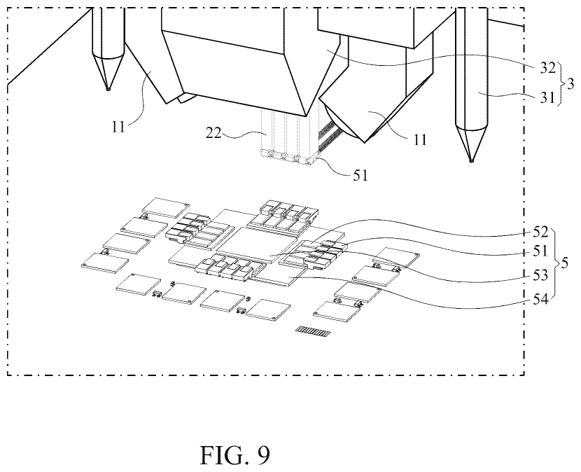

Referring to FIG. 9, FIG. 9 is a partially enlarged view of FIG. 8. As shown in FIG. 9, it illustrates that the photonic integrated circuits 52 on each side of the load board 54 are optically connected to the optical coupling structures 51 through the apparatus 100.

Accordingly, in the present application, the multiaxial adjustment device of the apparatus, in response to receiving the image signals output from the imaging device spatially and electronically scanning the site where the optical coupling structure is to be positioned, adjusts the positions of the optical coupling structures to enable a precise optical alignment between the optical coupling structures and the photonic integrated circuits respectively and simultaneously, thus achieving efficient and less time-consuming optical alignment.

Although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. An apparatus for aligning an optical coupling structure with a photonic integrated circuit, the apparatus comprising:
at least an imaging device configured to generate a three-dimensional image reflecting positional relation between the optical coupling structure and the photonic integrated circuit; and
a multiaxial adjustment device electrically connected to the imaging device and comprising at least an adjustment platform and at least a holding arm connected to the adjustment platform, the holding arm holding the optical coupling structure and being movable under control of the adjustment platform according to the three-dimensional image for the alignment between the optical coupling structure and the photonic integrated circuit.

2. The apparatus for aligning the optical coupling structure with the photonic integrated circuit of claim 1, wherein a plurality of the imaging devices are provided, each of the imaging devices comprises a fixing arm and a scanning module disposed on the fixing arm, and the scanning module comprises a scanning head located facing the optical coupling structure and the photonic integrated circuit.

3. The apparatus for aligning the optical coupling structure with the photonic integrated circuit of claim 2, wherein a plurality of the adjustment platforms and the holding arms are provided, and each of the holding arms is independently adjustable in position under control of a respective one of the adjustment platforms.

4. The apparatus for aligning the optical coupling structure with the photonic integrated circuit of claim 3, wherein the holding arms are arranged in alignment with each other, and the scanning modules are located at opposite sides of the two outermost holding arms.

5. The apparatus for aligning the optical coupling structure with the photonic integrated circuit of claim 3, wherein the holding arms are simultaneously adjustable in position to hold and actively align a plurality of the optical coupling structures with a plurality of the photonic integrated circuits, respectively.

6. The apparatus for aligning the optical coupling structure with the photonic integrated circuit of claim 3, wherein at least four adjustment platforms and at least four holding arms are provided, the adjustment platforms are arranged above the scanning modules, and the holding arms hold the optical coupling structures in such a way that the optical coupling structures are arranged to be flush with each other.

7. The apparatus for aligning the optical coupling structure with the photonic integrated circuit of claim 2, wherein each of the scanning modules is adjustable in position relative to the holding arms.

8. The apparatus for aligning the optical coupling structure with the photonic integrated circuit of claim 2, wherein the multiaxial adjustment device further comprises a suspending member disposed above the photonic integrated circuit, one end of the fixing arm is connected to a side of the suspending member, the scanning head of the scanning module is disposed outside the other end of the fixing arm, and the adjustment platform is disposed on another side of the suspending member.

9. The apparatus for aligning the optical coupling structure with the photonic integrated circuit of claim 2, wherein the holding arm comprises a holding head disposed on one end of the holding arm, and the holding head is configured to hold the optical coupling structure.

10. The apparatus for aligning the optical coupling structure with the photonic integrated circuit of claim 1, further comprising a dispensing device, wherein the dispensing device is configured to apply a curing substance on the photonic integrated circuits and fix a position of the optical coupling structure.

11. The apparatus for aligning the optical coupling structure with the photonic integrated circuit of claim 10, wherein the dispensing device comprises at least a dispensing tube and at least a curing element, the dispensing tube dispenses the curing substance, and the curing element cures the curing substance.

12. The apparatus for aligning the optical coupling structure with the photonic integrated circuit of claim 10, wherein a plurality of the curing elements are arranged on opposite sides of the holding arm, and the dispensing tube is movable to the optical coupling structure according to the three-dimensional image.

13. The apparatus for aligning the optical coupling structure with the photonic integrated circuit of claim 1, wherein a co-packaged optics assembly is provided and comprises a main board, an electronic integrated circuit, a load board, and the photonic integrated circuit, and the photonic integrated circuit, the electronic integrated circuit, and the load board are electrically arranged on the main board.
